(19) United States
(12) Patent Application Publication
(10) Pub. No.: US 2002/0185625 A1
(43) Pub. Date: Dec. 12, 2002

(54) Leakproof ball valve structure

(76) Inventor: Frank Gosling, Oakville (CA)

Correspondence Address: ROSENBERG, KLEIN & LEE, 3458 ELLICOTT CENTER DRIVE-SUITE 101, ELLICOTT CITY, MD, 21043, US

(21) Appl. No.: 09/876,028

(22) Filed: Jun. 8, 2001

(51) Int. Cl. F16K 5/06

(52) U.S. Cl. 251/315.01

(57) ABSTRACT

A leakproof ball valve structure includes a body receiving a ball that is driven by a central shaft. A leakproof assembly is respectively mounted between the body and a side cover. The leakproof assembly includes a retaining ring having a first end formed with a flange closely fit in the body, and a second end formed with a fitting portion rested on the side cover, and a seal ring secured in the retaining ring and urged on the ball. The fitting portion of the retaining ring is serially provided with a leakproof ring, a washer, and an elastic. Thus, the elastic force of the elastic member will not be reduced due to pressure, thereby enhancing the leakproof effect of the ball valve and the lifetime of the elastic member.

### BACKGROUND OF THE INVENTION

1. Field of the Invention

The present invention relates to a leakproof ball valve structure.

2. Description of the Related Prior Art

A conventional ball valve in accordance with the prior art shown in FIGS. 6 and 7 comprises a body 10 receiving a ball 30 (the ball 30 defining a flow hole 31) and having two sides each combined with a side cover 20, and a leakproof member 80 mounted between the ball 30 and the side cover 20. The leakproof member 80 includes a seal ring 81, a resting ring 82, a leakproof ring 83, a washer 84, and an elastic pad 85. The front end of the resting ring 82 is formed with a friction face 821, and the seal ring 81 that is wear-proof is secured in the friction face 821, and is in contact with the ball 30. The elastic force of the elastic pad 85 presses the resting ring 82 toward the ball 30, so that the seal ring 81 secured in the resting ring 82 is urged on the ball 30, thereby achieving a leakproof effect.

However, when the ball valve is closed, one side of the ball valve that supplies the fluid will produce a pressure to press the ball 30 which presses the elastic pad 85, so that the elastic pad 85 will produce excessive deformation due to being compressed during a long period of time, thereby decreasing the lifetime of the elastic pad 85, and thereby decreasing the leakproof effect of the conventional ball valve.

### SUMMARY OF THE INVENTION

The present invention has arisen to mitigate and/or obviate the disadvantage of the conventional ball valve.

In accordance with the present invention, there is provided a leakproof ball valve structure, comprising:

a body having a center defining a through hole;

a ball received in the through hole of the body;

a central shaft mounted on the body for rotating the ball;

two side covers each respectively secured on one of two sides of the through hole of the body;

two leakproof assemblies each mounted between the body and a respective side cover;

wherein, each of the two leakproof assemblies includes:

a retaining ring having a first end facing the ball and formed with a flange which has an outer periphery closely fit in an inner wall of the through hole of the body, and having a second end formed with a fitting portion rested on a respective side cover and having an outer diameter smaller than that of the flange;

a seal ring secured in the first end of the retaining ring and urged on an outer wall of the ball;

a leakproof ring mounted on an outer periphery of the fitting portion of the retaining ring and rested on the flange of the retaining ring;

a washer mounted on the outer periphery of the fitting portion of the retaining ring and rested on the leakproof ring; and

an elastic member mounted on the outer periphery of the fitting portion of the retaining ring and urged between the washer and the respective side cover.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a leakproof ball valve structure in accordance with a first embodiment of the present invention;

FIG. 2 is a side plan cross-sectional assembly view of the leakproof ball valve structure as shown in FIG. 1;

FIG. 3 is a partially cut-away enlarged view of the leakproof ball valve structure as shown in FIG. 2;

FIG. 3-1 is a schematic operational view of the leakproof ball valve structure as shown in FIG. 3;

FIG. 4 is a schematic operational view of the leakproof ball valve structure as shown in FIG. 3;

FIG. 5 is a side plan cross-sectional assembly view of a leakproof ball valve structure in accordance with a second embodiment of the present invention.

FIG. 6 is a side plan cross-sectional view of a conventional ball valve in accordance with the prior art; and

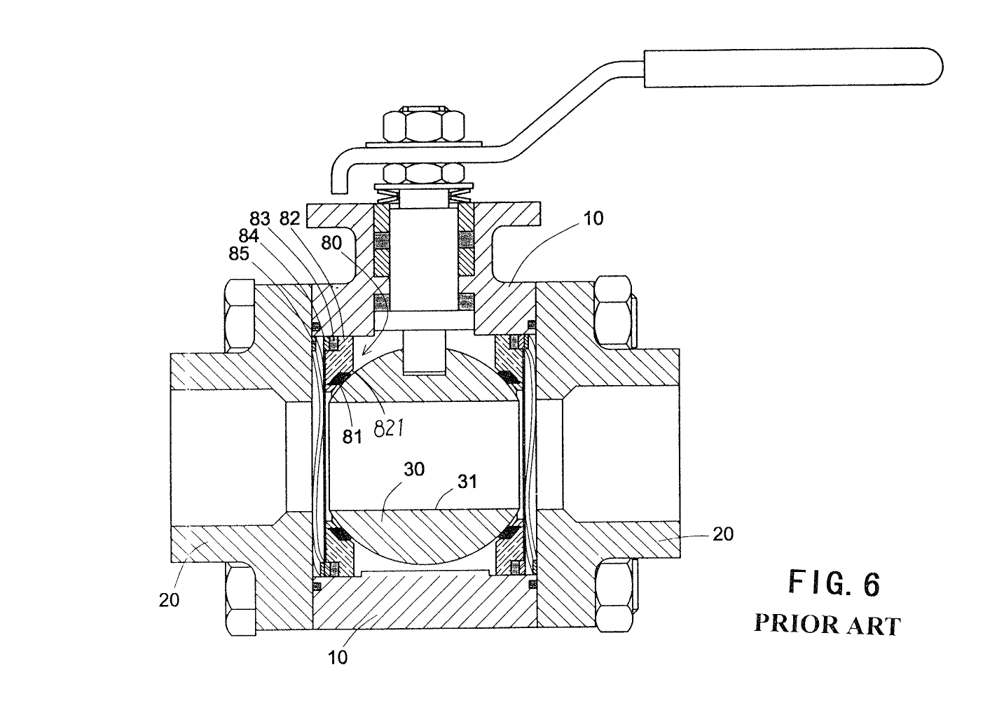

FIG. 7 is a partially cut-away enlarged view of the conventional ball valve as shown in FIG. 6.

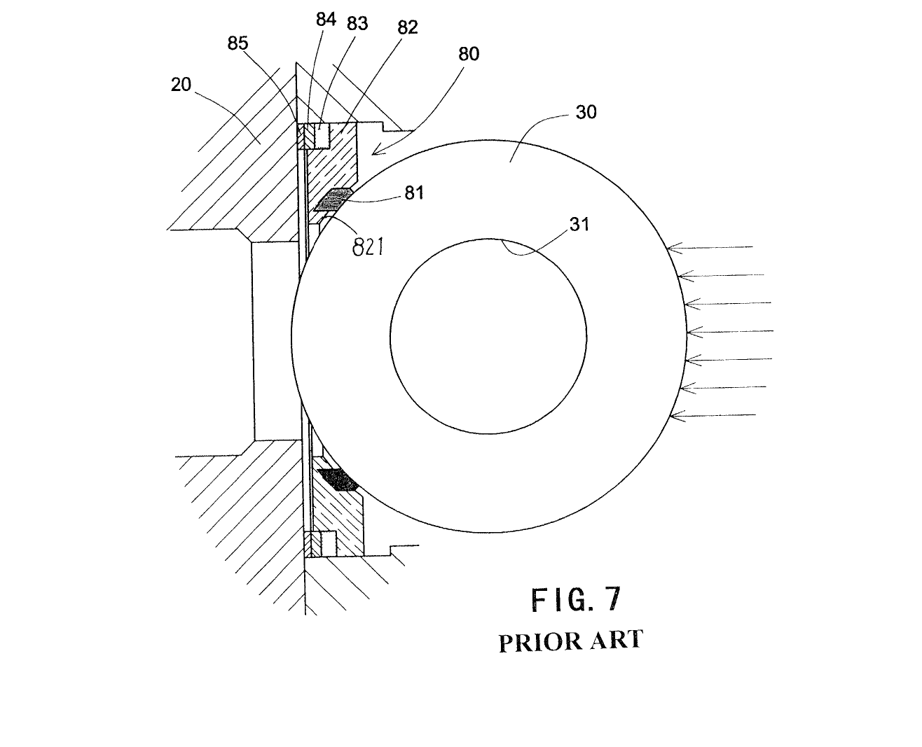

### DETAILED DESCRIPTION OF THE INVENTION

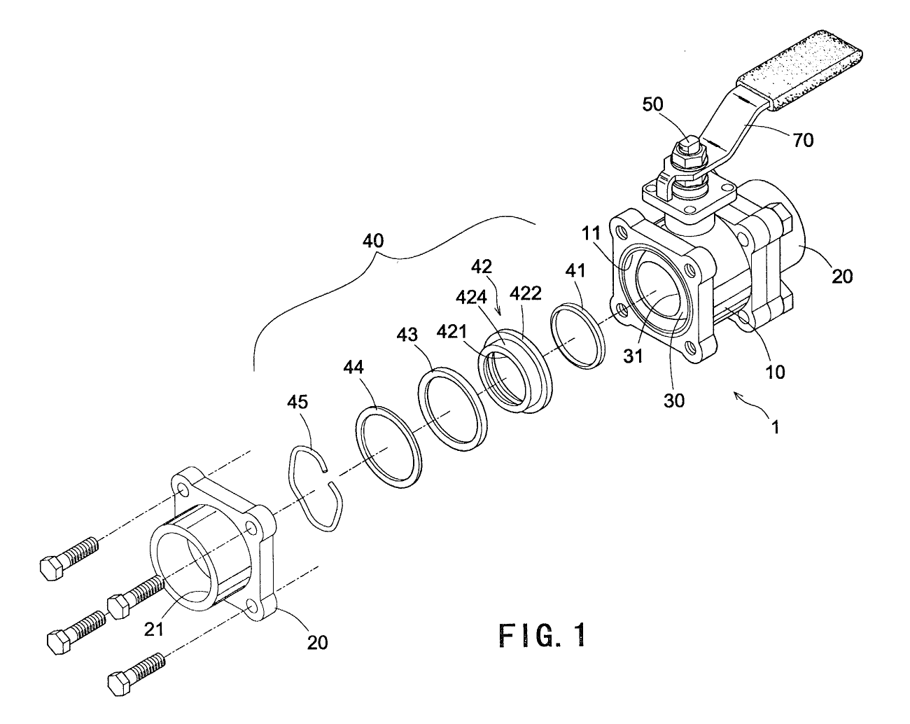

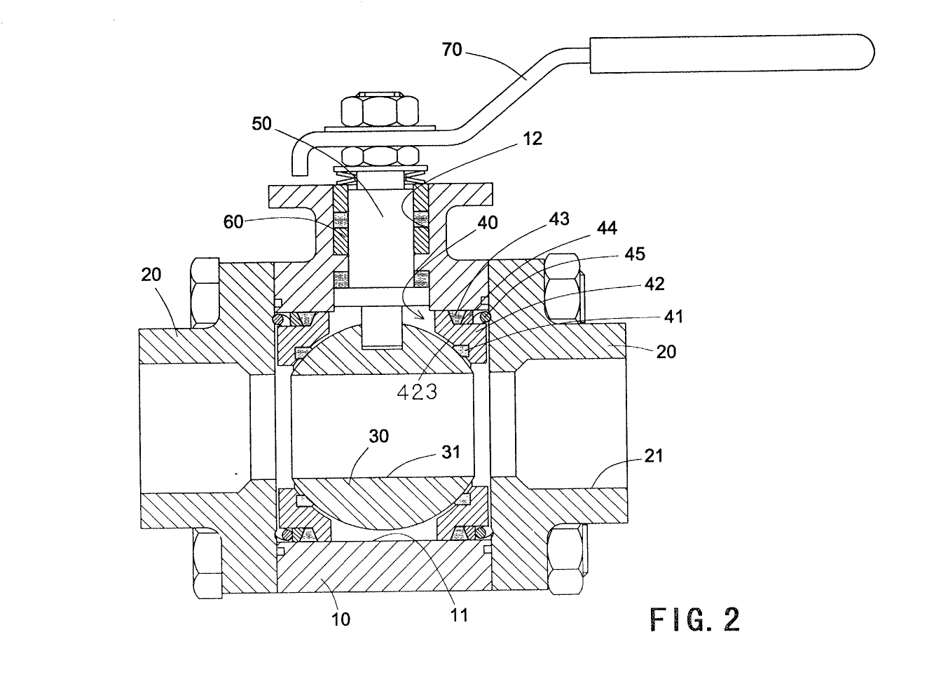

Referring to the drawings and initially to FIGS. 1-3, a leakproof ball valve structure 1 in accordance with a first embodiment of the present invention comprises a body 10, two side covers 20, a ball 30, two leakproof assemblies 40, and a central shaft 50.

The body 10 has a center defining a through hole 11 for receiving the ball 30, and a vertical through hole 12 communicating with the through hole 11 for receiving the central shaft 50.

The ball 30 is received in the through hole 11 of the body 10, and has a center defining a flow hole 31.

The central shaft 50 has a first end secured in the ball 30 for rotating the ball 30, and a second end extended outward from the vertical through hole 12 of the body 10 and combined with a handle 70 for driving the ball 30 to rotate. A plurality of leakproof members 60 mounted between the central shaft 50 and the vertical through hole 12 of the body 10, thereby preventing the fluid from leaking.

Each of the two leakproof assemblies 40 is mounted between the body 10 and a respective side cover 20, and includes a retaining ring 42, a seal ring 41, and leakproof ring 43, and washer 44, and an elastic member 45.

The retaining ring 42 has a center defining a through hole 421. The retaining ring 42 has a first end facing the ball 30 and formed with a flange 422 which has an outer periphery closely fit in the inner wall of the through hole 11 of the body 10, and has a second end formed with a fitting portion 424 rested on the respective side cover 20 and having an outer diameter smaller than that of the flange 422. The first end of the retaining ring 42 is formed with an arcuate face 423, so that the arcuate face 423 of the two retaining rings 42 may form a space for receiving the ball 30. The arcuate face 423 defines an annular insertion groove 4231 for securing the seal ring 41 that is wear-proof and is resistant to a high temperature.

The seal ring 41 has one side protruded from the arcuate face 423 and formed with an arcuate abutting face 410 urged on the outer wall of the ball 30 for clamping and positioning the ball 30.

The leakproof ring 43 is mounted on the outer periphery of the fitting portion 424 of the retaining ring 42 and is rested on the flange 422 of the retaining ring 42. The leakproof ring 43 has a wedge-shaped cross-section. The flange 422 of the retaining ring 42 has one side formed with an inclined face 4221 abutting the wedge-shaped face of the leakproof ring 43. The washer 44 has one side formed with an inclined face 441 abutting the wedge-shaped face of the leakproof ring 43.

The washer 44 is mounted on the outer periphery of the fitting portion 424 of the retaining ring 42 and is rested on the leakproof ring 43.

The elastic member 45 is mounted on the outer periphery of the fitting portion 424 of the retaining ring 42 and is urged between the washer 44 and the respective side cover 20. Preferably, the elastic member 45 has an annular corrugated shape.

Each of the two side covers 20 is respectively secured on one of two sides of the through hole 11 of the body 10 and is rested on the retaining ring 42 of the leakproof assembly 40, so that the leakproof assembly 40 can clamp and positioning the ball 30 exactly. Each side cover 20 has a center defining a through hole 21 communicating with the through hole 11 of the body 10. Each side cover 21 defines an annular groove 22 for positioning the elastic member 45. Thus, the elastic member 45 is slightly pressed to urge the retaining ring 42 elastically, so that the arcuate abutting face 410 of the seal ring 41 secured in the retaining ring 42 is entirely and closely urged on the outer wall of the ball 30 for clamping and positioning the ball 30.

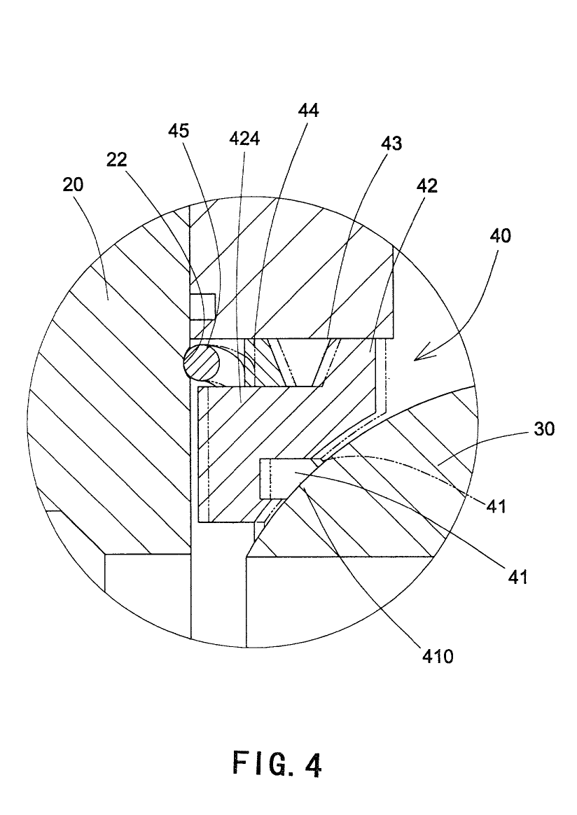

Thus, when the seal ring 41 urged on the ball 30 is worn, the elastic force of the elastic member 45 will force the entire leakproof assembly 40 to displace toward the ball 30 as shown in phantom lines in FIG. 4, so that the seal ring 41 is in contact with the ball 30 constantly, thereby achieving a leakproof effect of an automatic compensation.

In addition, when the ball valve structure 10 is closed, one side of the ball valve structure 10 that supplies the fluid will produce a pressure to press the ball 30. The fitting portion 424 of the retaining ring 42 of the leakproof assembly 40 of the ball valve structure 10 is used for receiving the elastic member 45, such that the elastic member 45 is allowed to have a determined amount of deformation due to the fitting portion 424. The retaining ring 42 of the leakproof assembly 40 is rested on the side cover 20, so that the retaining ring 42 can support the pressure of the fluid on the ball 30, thereby preventing the elastic member 45 from producing an excessive deformation due to being compressed during a long period of time, so as to increase the lifetime of the elastic member 45, and so as to enhance the leakproof effect of the ball valve structure 10.

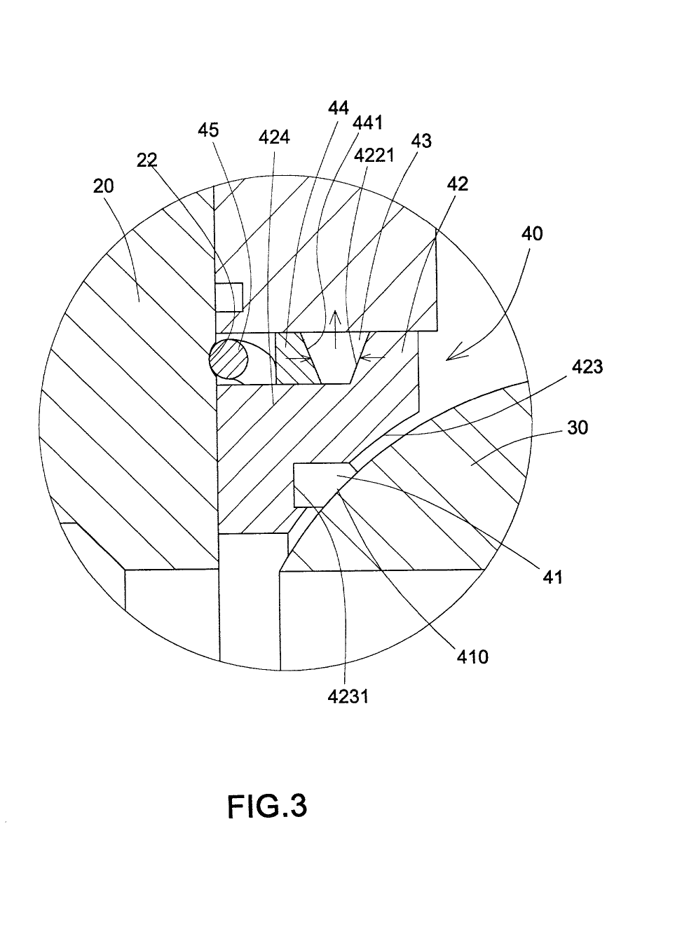

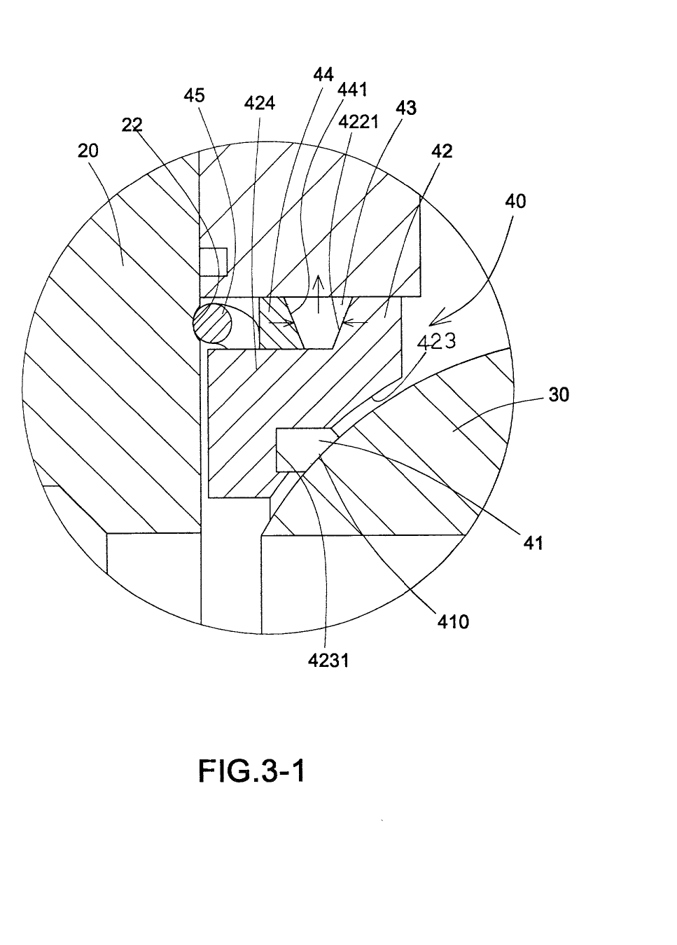

Further, as shown in FIG. 3, the leakproof ring 43 has a symmetrical wedge-shaped cross-section. The two inclined sides of the leakproof ring 43 are urged by the inclined face 4221 of the flange 422 of the retaining ring 42 and the inclined face 441 of the washer 44. Thus, the washer 44 is pressed by the elastic force of the elastic member 45 to compress the two inclined sides of the leakproof ring 43, so that the leakproof ring 43 is displaced to press the inner wall of the through hole 11 of the body 10. Thus, the outer wall of the leakproof ring 43 is closely fit with the inner wall of the through hole 11 of the body 10, thereby enhancing the leakproof effect.

As shown in FIG. 3-1, the leakproof ball valve structure 1 is disposed at a fully opened state (without a pressure load), wherein the upstream and the downstream connect with each other. A gap is defined between the fitting portion 424 of the retaining ring 42 and the side cover 20, and has a width of about 1˜2 mm. In such a manner, the pressure load of the elastic member 45 is ranged between 50% and 65%.

As shown in FIG. 3, the leakproof ball valve structure 1 is disposed at a fully closed state (the pressure load is applied), wherein the upstream and the downstream do not connect with each other. Thus, there is no gap between the fitting portion 424 of the retaining ring 42 and the side cover 20. In such a manner, the pressure load of the elastic member 45 is about 85%.

By the design of the present invention, the elastic member 45 is received in the space defined between the inner wall of the body 10 and the fitting portion 424 of the retaining ring 42, so that the elastic member 45 will not be compressed excessively by the side cover 20 and the retaining ring 42, thereby preventing the elastic member 45 from being subjected to an excessive compressed load during a long period of time, so as to increase the lifetime of the elastic member 45, and so as to enhance the leakproof effect of the ball valve structure 10.

Referring to FIG. 4, if the seal ring 41 is worn out due to successive opening and closing actions, the elastic member 45 will force the leakproof assembly 40 to displace toward the ball 30 as shown in phantom lines, so that the seal ring 41 is in contact with the ball 30 constantly, thereby achieving an automatic compensation effect.

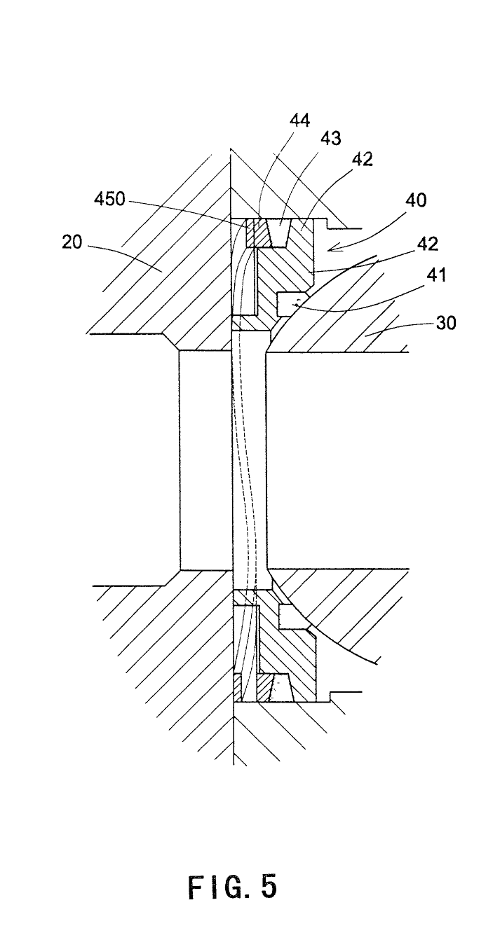

Referring to FIG. 5, in accordance with a second embodiment of the present invention, the elastic member 45 is made into an elastic sheet circle 450 having a corrugated shape.

While the preferred embodiment of the present invention has been shown and described, it will be apparent to those skilled in the art that various modifications may be made in the embodiment without departing from the spirit of the present invention. Such modifications are all within the scope of the present invention.

What is claimed is:

1. A leakproof ball valve structure, comprising:
a body (10) having a center defining a through hole (11);
a ball (30) received in said through hole (11) of said body (10);
a central shaft (50) mounted on said body (10) for rotating said ball (30);
two side covers (20) each respectively secured on one of two sides of said through hole ( 11) of said body (10);
two leakproof assemblies (40) each mounted between said body (10) and a respective side cover (20);
wherein, each of said two leakproof assemblies (40) includes:
a retaining ring (42) having a first end facing said ball (30) and formed with a flange (422) which has an outer periphery closely fit in an inner wall of said through hole (11) of said body (10), and having a second end formed with a fitting portion (424) rested on a respective side cover (20) and having an outer diameter smaller than that of said flange (422);
a seal ring (41) secured in said first end of said retaining ring (42) and urged on an outer wall of said ball (30);
a leakproof ring (43) mounted on an outer periphery of said fitting portion (424) of said retaining ring (42) and rested on said flange (422) of said retaining ring (42);
a washer (44) mounted on said outer periphery of said fitting portion (424) of said retaining ring (42) and rested on said leakproof ring (43); and
an elastic member (45) mounted on said outer periphery of said fitting portion (424) of said retaining ring (42) and urged between said washer (44) and said respective side cover (20).

2. The leakproof ball valve structure in accordance with claim 1, wherein said elastic member (45) has an annular corrugated shape.

3. The leakproof ball valve structure in accordance with claim 1, wherein said leakproof ring (43) has a wedge-shaped cross-section.

4. The leakproof ball valve structure in accordance with claim 3, wherein said flange (422) of said retaining ring (42) has one side formed with an inclined face (4221) abutting a wedge-shaped face of said leakproof ring (43).

5. The leakproof ball valve structure in accordance with claim 3, wherein said washer (44) has one side formed with an inclined face (441) abutting a wedge-shaped face of said leakproof ring (43).

6. The leakproof ball valve structure in accordance with claim 1, wherein said side cover (21) defines an annular groove (22) for positioning said elastic member (45).
